(19) United States
(12) Patent Application Publication
(10) Pub. No.: US 2022/0025180 A1
(43) Pub. Date: Jan. 27, 2022

(54) UV AND/OR HEAT CURABLE SILICONE BASED MATERIALS AND FORMULATIONS

(71) Applicants: Henkel IP & Holding GmbH, Duesseldorf (DE); Henkel AG & Co. KGaA, Duesseldorf (DE)

(72) Inventors: Bahram Issari, Glastonbury, CT (US); Christina Despotopoulou, Minneapolis, MN (US); Johann Klein, Duesseldorf (DE); Tianzhi Zhang, Skillman, NJ (US)

(21) Appl. No.: 17/496,853

(22) Filed: Oct. 8, 2021

Related U.S. Application Data
(63) Continuation of application No. PCT/US2020/026815, filed on Apr. 6, 2020.
(60) Provisional application No. 62/830,622, filed on Apr. 8, 2019.

(51) Int. Cl. C08L 83/04; C08G 77/20; C08G 77/12; C08G 77/00; C08G 77/26; C08F 220/36

(52) U.S. Cl. CPC C08L 83/04; C08G 77/20; C08G 77/12; C08G 77/80; C08L 2312/06; C08F 220/36; C08G 2170/00; C08G 2190/00; C08G 77/26

(57) ABSTRACT

The present disclosure is directed to a process for the preparation of curable, (meth)acrylate functionalized polysiloxanes. In addition, the present disclosure is directed to a curable, (meth)acrylate-functionalized polysiloxane obtained thereby and curable compositions comprising these curable, (meth)acrylate-functionalized polysiloxanes.

### FIELD

The present disclosure is directed to a process for the preparation of a curable, (meth)acrylate functionalized polysiloxane polymer. In addition, the present disclosure is directed to the curable, (meth)acrylate-functionalized polysiloxane polymers obtained thereby and curable compositions comprising these curable, (meth)acrylate-functionalized polysiloxane polymers.

### BACKGROUND

Adhesives are used in many industries to bond various substrates and assemblies together. Radiation curable adhesives can form crosslinks (cure) upon sufficient exposure to radiation such as electron beam radiation or actinic radiation such as ultraviolet (UV) radiation or visible light. UV radiation is in the range of 100 to 400 nanometers (nm). Visible light is in the range of 400 to 780 nanometers (nm).

Radiation curable polysiloxanes are desirable as they can be used to formulate radiation curable adhesives and sealants. Further, the polysiloxane backbone provides desirable flexibility and temperature resistance to the cured material.

### SUMMARY

In accordance with a first aspect of the present disclosure there is provided a method for producing a curable, (meth)acrylate functionalized polysiloxane.

In accordance with a second aspect of the present disclosure, there are provided UV curable (meth)acrylate-functionalized polysiloxanes made by these methods.

In accordance with a third aspect of the present disclosure, there are provided UV and/or heat curable compositions, in particular UV and/or heat curable adhesive, sealant or coating compositions, comprising these curable, (meth)acrylate-functionalized polysiloxanes.

### BRIEF DESCRIPTION OF THE DRAWINGS

Referring now to the drawings wherein like elements are numbered alike in the several FIGURES:

FIG. 1 is a schematic representation of a reaction scheme for preparing di(meth)acrylate terminated silicone polymers.

### DETAILED DESCRIPTION

The singular forms “a”, “an” and “the” include plural referents unless the context clearly dictates otherwise. “About” or “approximately” as used herein in connection with a numerical value refer to the numerical value ±10%, preferably ±5% and more preferably ±1% or less.

The terms “comprising”, “comprises” and “comprised of” as used herein are synonymous with “including”, “includes”, “containing” or “contains”, and are inclusive or open-ended and do not exclude additional, non-recited members, elements or method steps.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

The words “preferred” and “preferably” are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

The molecular weights given in the present text refer to number average molecular weights (Mn), unless otherwise stipulated. All molecular weight data refer to values obtained by gel permeation chromatography (GPC) calibrated against polystyrene standards in accordance with DIN 55672-1:2007-08 at 35° C., unless otherwise stipulated.

“Polydispersity index” refers to a measure of the distribution of molecular mass in a given polymer sample. The polydispersity index is calculated by dividing the weight average molecular weight (Mw) by the number average molecular weight (Mn).

For convenience in the description of the process, unsaturation provided by CH₂═CH—CH₂— terminal group is referred to as “allyl” unsaturation.

“Alkyl” refers to a monovalent group that contains carbon atoms and hydrogen atoms, for example 1 to 8 carbons atoms, that is a radical of an alkane and includes linear and branched configurations. Examples of alkyl groups include, but are not limited to: methyl; ethyl; propyl; isopropyl; n-butyl; isobutyl; sec-butyl; tert-butyl; n-pentyl; n-hexyl; n-heptyl; and, 2-ethylhexyl. In the present invention, such alkyl groups may be unsubstituted or may optionally be substituted. Preferred substituents include one or more groups selected from halo, nitro, cyano, amido, amino, sulfonyl, sulfinyl, sulfanyl, sulfoxy, urea, thiourea, sulfamoyl, sulfamide and hydroxy. The halogenated derivatives of the exemplary hydrocarbon radicals listed above might, in particular, be mentioned as examples of suitable substituted alkyl groups. Preferred alkyl groups include unsubstituted alkyl groups containing from 1-6 carbon atoms (C₁-C₆ alkyl)—for example unsubstituted alkyl groups containing from 1 to 4 carbon atoms (C₁-C₄ alkyl).

“Heteroatom” is an atom other than carbon or hydrogen, for example nitrogen, oxygen, phosphorus or sulfur.

“Heteroalkyl” refers to a monovalent alkyl group that contains carbon atoms interrupted by at least one heteroatom and includes linear and branched configurations. Heteroalkyl groups may be unsubstituted or may be optionally substituted. Preferred substituents include one or more groups selected from halo, nitro, cyano, amido, amino, oxygen, sulfonyl, sulfinyl, sulfanyl, sulfoxy, urea, thiourea, sulfamoyl, sulfamide and hydroxy.

“Alkylene” refers to a divalent group that contains carbon atoms, for example from 1 to 20 carbon atoms, that is a radical of an alkane and includes linear and branched organic groups, which may be unsubstituted or optionally substituted. Preferred alkylene groups include unsubstituted alkylene groups containing from 1-12 carbon atoms (C₁-C₁₂ alkylene)—for example unsubstituted alkylene groups containing from 1 to 6 carbon atoms (C₁-C₆ alkylene) or from 1 to 4 carbons atoms (C₁-C₄ alkylene).

“Heteroalkylene” refers to a divalent alkylene group that contains carbon atoms interrupted by at least one heteroatom and includes linear and branched configurations, which may be unsubstituted or optionally substituted.

“Alkenyl” group refers to an aliphatic carbon group that contains carbon atoms, for example 2 to 8 carbon atoms and at least one double bond. Like the aforementioned alkyl group, an alkenyl group can be straight or branched, and may be unsubstituted or may be optionally substituted. Examples of C₂-C₈ alkenyl groups include, but are not limited to: allyl; isoprenyl; 2-butenyl; and, 2-hexenyl.

“Cycloalkyl” refers to a saturated, mono-, bi- or tricyclic hydrocarbon group having from 3 to 10 carbon atoms. Examples of cycloalkyl groups include: cyclopropyl; cyclobutyl; cyclopentyl; cyclohexyl; cycloheptyl; cyclooctyl; adamantane; and, norbornane.

“Aryl” group used alone or as part of a larger moiety—as in “aralkyl group”—refers to unsubstituted or optionally substituted, monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. Exemplary aryl groups include phenyl; indenyl; naphthalenyl, tetrahydronaphthyl, tetrahydroindenyl; tetrahydroanthracenyl; and, anthracenyl.

“Arylene” is a bivalent aryl group and may be unsubstituted or optionally substituted.

“Aralkyl” refers to an alkyl group that is substituted with an aryl group. An example of an aralkyl group is benzyl.

“(Meth)acrylate” refers to acrylate and methacrylate.

“Acrylate” refers to the univalent —O—C(O)—C═C moiety.

“Methacrylate” refers to the univalent —O—C(O)—C(CH₃)═C moiety.

“Acryloyl” refers to a —C(O)—C═C moiety.

“Anhydrous” means that the applicable mixture or component comprises less than 0.1 wt. % of water, based on the weight of the mixture or component.

“Catalytic amount” means a sub-stoichiometric amount of catalyst relative to a reactant.

“Isocyanate” means a compound which comprises only one isocyanate (—NCO) group. The isocyanate compound does not have to be a polymer, and can be a low molecular weight compound.

“Ether” refers to a compound having an oxygen atom connected to two alkyl or aryl groups.

“Polyether” refers to a compound having more than one ether group. Exemplary polyethers include polyoxymethylene, polyethylene oxide and polypropylene oxide.

Where mentioned, the expression “interrupted by at least one heteroatom” means that the main chain of a residue comprises, as a chain member, at least one atom that differs from carbon atom.

A “secondary alcohol group” or a “secondary hydroxyl group” is constituted by a hydroxy group (—OH) attached to a saturated carbon atom which has two other carbon atoms attached to it. Analogously, a “tertiary alcohol group” or “tertiary hydroxyl group” is constituted by a hydroxy group (—OH) attached to a saturated carbon atom which has three other carbon atoms attached to it.

“Polyisocyanate” means a compound which comprises two or more isocyanate (—NCO) groups. The polyisocyanate compound does not have to be a polymer, and can be a low molecular weight compound.

“Polymerization conditions” means the reaction conditions suitable to combine monomers into polymers. In one embodiment the polymerization conditions include those conditions necessary for ring-opened cyclic siloxanes to combine with one another to form a silicone polymer within a polymer matrix.

“Ring-opening polymerization” denotes a polymerization in which a cyclic compound (monomer) is opened to form a linear polymer. Ring-opening polymerization with respect to siloxane chemistry specifically relates to a polymerization reaction using cyclosiloxane monomers, in which reaction the ring of the cyclosiloxane monomer is opened in the presence of an appropriate catalyst. The reaction system tends towards an equilibrium between the desired resulting high-molecular compounds, a mixture of cyclic compounds and/or linear oligomers, the attainment of which equilibrium largely depends on the nature and amount of siloxane(s), the catalyst used and on the reaction temperature. The use of solvents and/or emulsions in the polymerization is not recommended and should be avoided as their removal once the reaction is complete can be complex. Various mechanisms of anionic and cationic ring opening polymerization of cyclic siloxane monomers which might find utility in the present invention are disclosed inter alia in: i) Lebedev, B. V et al. Thermodynamics of Poly(dimethyldisiloxane) in the Range of 0-350 K. Vysokomol. Soed. Ser. A (1978), 20, pages 1297-1303; ii) Duda, A. et al. Thermodynamics and Kinetics of Ring-Opening Polymerization in Handbook of Ring-Opening Polymerization, Wiley-VCH, Weinheim, Germany, (2009) page 8; iii) Ackermann, J. et al. Chemie und Technologie der Silikone II. Herstellung und Verwendung von Siliconpolymeren, Chemie in unserer Zeit (1989), 23, pages 86-99; and, iv) Chojnowski, J. et al. Cationic Polymerization of Siloxanes Die Macromolekulare Chemie 175, pp. 3299-3303 (1974); v) Choijnowski, J. et al. Kinetically controlled ring-opening polymerization, J. Inorg. Organomet. Polym. (1991) 1, pages 299-323; and, vi) Nuyken et al. Ring-Opening Polymerization—An Introductory Review Polymers 2013, 5, 361-403.

“Substituted” refers to the replacement of an atom in any possible position on a molecule by one or more substituent groups. Useful substituent groups are those groups that do not significantly diminish the disclosed reactions. Exemplary substituents include, for example, alkyl, alkenyl, alkynyl, cycloalkyl, cycloalkenyl, cycloalkynyl, aryl, aralkyl, heteroaryl, heteroalicyclyl, heteroaralkyl, heteroalkenyl, heteroalkynyl, (heteroalicyclyl)alkyl, aryloxy, acyl, ester, mercapto, alkylthio, arylthio, carbonyl, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, silyl, sulfenyl, sulfinyl, sulfonyl, haloalkoxy, trihalomethanesulfonyl, trihalomethanesulfonamido, amino including mono- and di-substituted amino groups and the protected derivatives thereof. carbamate, halogen, (meth)acrylate, epoxy, oxetane, urea, urethane, N₃, NCS, CN, NO₂, NX¹X², OX¹, C(X¹)₃, COOX¹, SX¹, Si(OX¹)ᵢX²₃₋ᵢ, alkyl, alkoxy; wherein each X¹ and each X² independently comprise H, alkyl, alkenyl, alkynyl, aryl or halogen and i is an integer from 0 to 3.

In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

In preferred embodiments the curable (meth)acrylate terminated polysiloxane polymer has structure I

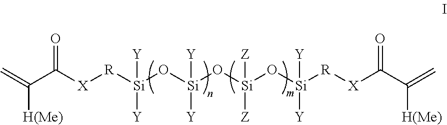

Each X is independently selected from O or N.

Each R is a bivalent moiety independently selected from alkylene, heteroalkylene, arylene, heteroarylene, aralkylene, amine; urethane; urea; ether, ester and combinations thereof. In some embodiments R can be C₁₋₆ alkylene, -alkylene-urethane-ether-, -amine-alkylene- and alkylene-urea-alkylene-.

Each Y is independently selected from H, alkyl and aryl.

Each Z is independently selected from H, alkyl and aryl. In some embodiments each Si atom in the m block has one phenyl Z moiety and one C₁₋₃ alkyl Z moiety.

n is an integer from about 1 to about 2300.

m is an integer from 0 to about 2300. If m is greater than 1, then the n blocks and the m blocks can be arranged in any order. Thus structure I can have a block copolymer structure comprising a n-n-n-m-m-m blocks or an alternate copolymer structure comprising a n-m-n-m-n-m block structure or a random copolymer structure comprising randomly arranged n and m blocks.

In some embodiments n+m is 200 or greater, preferably 100 or greater and more preferably 1200 or greater. In some embodiments where each Y is alkyl, each R is alkylene, each X is O and the O atom is bonded to a primary carbon atom, than n+m is 1000 or greater, preferably 1100 or greater; more preferably 1200 or greater.

The curable (meth)acrylate terminated polysiloxane polymer can be prepared by a number of reactions. In one embodiment a curable, (meth)acrylate terminated polysiloxane polymer is the reaction product of a dicarbinol silicone polymer and a (meth)acrylate terminated isocyanate. In another embodiment a curable, (meth)acrylate terminated polysiloxane polymer is the reaction product of one or more cyclic siloxanes and a di(meth)acrylate terminated siloxane oligomer. In another embodiment a curable, (meth)acrylate terminated polysiloxane polymer is the reaction product of an amine terminated siloxane and a (meth)acrylate terminated isocyanate. In another embodiment a curable, (meth)acrylate terminated polysiloxane polymer is the reaction product of an amine terminated siloxane and an acrylic acid chloride. In one embodiment a curable, (meth)acrylate terminated polysiloxane polymer is the reaction product of a dicarbinol silicone polymer and an acrylic acid chloride.

Preparation of a curable, (meth)acrylate terminated polysiloxane polymer by reaction of a dicarbinol silicone polymer and a (meth)acrylate terminated isocyanate.

### Preparation of Dicarbinol Silicone Polymer—Step i

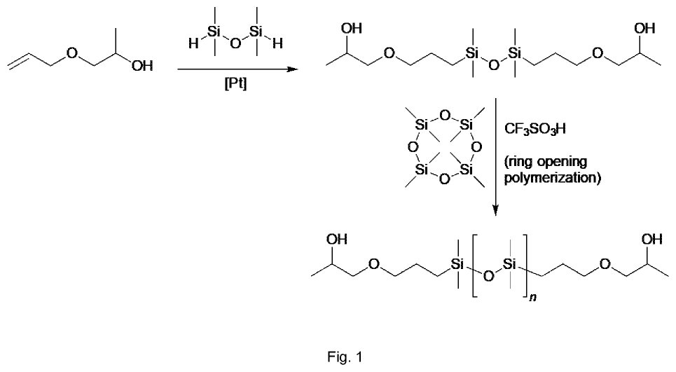

The dicarbinol silicone polymer can be prepared by in a first step reacting a hydroxyalkyl allyl ether having a secondary or tertiary alcohol group with a siloxane to form a reaction product and in a second step reacting that reaction product with at least one cyclic siloxane. One variation of this two step reaction is shown schematically in FIG. 1.

### Hydroxyalkyl-Allyl Ethers

Some useful hydroxyalkyl-allyl ethers possess allyl unsaturation and a secondary or tertiary hydroxyl group and conform to the following general Formula (I)

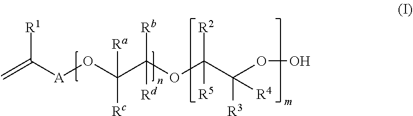

wherein n is 0, 1, 2, 3, 4 or 5, preferably 0; m is 1, 2, 3, 4 or 5, preferably 1; A denotes a spacer group which is constituted by a covalent bond or a C₁-C₂₀ alkylene group; R¹ is selected from hydrogen, a C₁-C₈ alkyl group, a C₃-C₁₀ cycloalkyl group, a C₆-C₁₈ aryl group or a C₆-C₁₈ aralkyl group; R^{a}, R^{b}, R^{c}, R^{d}, R², R³, R⁴ and R⁵ may be the same or different and each is independently selected from hydrogen, a C₁-C₈ alkyl group, a C₆-C₁₈ aryl group or a C₆-C₁₈ aralkyl group, with the proviso that at least one of R³ and R⁴ is not hydrogen.

Compounds conforming to Formula (I) are most suitably derived as alkylene oxide adducts of primary or secondary alcohols having ally unsaturation.

Said alcohols having allyl unsaturation will conform to Formula (IV) herein below:

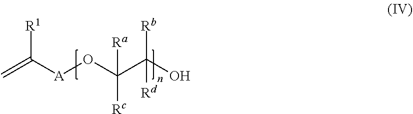

wherein n, A, R¹, R^{a}, R^{b}, R^{c} and R^{d} have the meanings assigned above. In a preferred embodiment: n is 0; A is either a covalent bond or a C₁-C₁₂ alkylene group; and, R¹ is selected from hydrogen and a C₁-C₆ alkyl group and, more preferably, from hydrogen and a C₁-C₄ alkyl group.

Suitable alcohols having allyl unsaturation for use in the present invention include: allyl alcohol; methallyl alcohol; 3-buten-1-ol; isoprenol (3-methyl-3-buten-1-ol); 2-methyl-3-buten-1-ol; 2-methyl-3-buten-2-ol; 1-penten-3-ol; 3-methyl-1-penten-3-ol; and, 4-methyl-1-penten-3-ol. Particular preference is given to using allyl alcohol or methallyl alcohol.

The alkylene oxide conforms to Formula (V) herein below

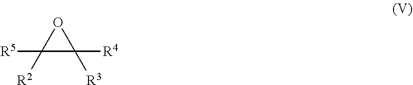

wherein R², R³, R⁴ and R⁵ may be the same or different and are independently selected from hydrogen, a C₁-C₈ alkyl group, a C₆-C₁₈ aryl group or a C₆-C₁₈ aralkyl group, with the proviso that at least one of R³ and R⁴ is not hydrogen. It is preferred that R², R³ and R⁵ are hydrogen and R⁴ is either a phenyl group or a C₁-C₈ alkyl group and, more preferably, a C₁-C₄ alkyl group.

Suitable alkylene oxide reactants include one or more of: propylene oxide; 1,2-butylene oxide; cis-2,3-epoxybutane; trans-2,3-epoxybutane; 1,2-epoxypentane; 1,2-epoxyhexane; decene oxide; and, styrene oxide. Particular preference is given to using propylene oxide.

Any known method for forming such adducts may be employed. However, commonly, in the presence of a basic catalyst, a controlled amount of alkylene oxide is slowly mixed with the preheated alcohol over a reaction time of up to 20 hours and in an amount sufficient to form the desired oxyalkylated reaction product. The unsaturated alcohol should be free of water and may therefore be vacuum stripped in advance of being preheated to a temperature, typically, of from 75 to 150° C.

During the introduction of the oxide, the concentration of unreacted alkylene oxide in the liquid reaction mixture and the current degree of addition of the alkylene oxide onto the unsaturated starter can be monitored by known methods. These methods include, but are not limited to optical methods, such as Infrared and Raman spectroscopy; viscosity and mass flow measurements, after appropriate calibration; measurement of the dielectric constant; and, gas chromatography.

If desired, the oxyalkylation may be carried out in a suitable solvent, such as an aromatic hydrocarbon—illustratively toluene or benzene—or, alternatively, an aliphatic hydrocarbon solvent having from 5 to 12 carbon atoms, such as heptane, hexane or octane. Where solvents are used, aliphatic solvents are preferred in order to obviate the potential toxic associations connected with use of aromatic hydrocarbon solvents.

Suitable basic catalysts, which may be used individually or in admixture, include alkali metal hydroxides such as KOH, NaOH and CsOH; alkaline earth metal hydroxides, such as Ca(OH)₂ and Sr(OH)₂; and, alkali metal alkoxides, such as KOMe, NaOMe, KOt-Bu and NaOt-Bu. The catalysts should typically be employed in an amount of from 0.05 to 0.5 wt. %, based on the total weight of the reactants and can be used either as solids, solutions or suspensions. It is also possible to add only part of the catalyst at the beginning of the reaction and introduce further catalysts in one or more portions at a later point in time; the later added fraction of catalyst may be identical or different to the initial catalyst and the amount of solvent present at each addition of catalyst can be moderated to ensure the efficacy of catalyst.

For completeness, illustrative citations describing the alkoxylation of allyl alcohol include: U.S. Pat. Nos. 9,073,836; 3,268,561; 4,618,703; and, J. Am. Chem. Soc. 71 (1949) 1152.

### Siloxanes

Some useful siloxanes are represented by the Formula (II) herein below:

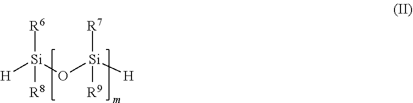

wherein m is 1, 2, 3, 4 or 5, preferably 1; R⁶, R⁷, R⁸ and R⁹ may be the same or different and each is independently selected from a C₁-C₈ alkyl group, a C₃-C₁₀ cycloalkyl group, a C₆-C₁₈ aryl group or a C₆-C₁₈ aralkyl group.

In a preferred embodiment, the siloxane of Formula (II) is a disiloxane.

In an embodiment, each of R⁶, R⁷, R⁸ and R⁹ represents a C₁-C₆ alkyl group or a C₃-C₆ cycloalkyl group. Preferably, each of R⁶, R⁷, R⁸ and R⁹ represents a C₁-C₄ alkyl group or a C₅-C₆ cycloalkyl group. For example, at least two of R⁶, R⁷, R⁸ and R⁹ may be a C₁-C₄ or C₁-C₂ alkyl group. Most particularly, it is preferred that each of R⁶, R⁷, R⁸ and R⁹ of Formula (II) are methyl (C₁).

For completeness, an illustrative list of siloxanes of Formula (II) include: 1,1,3,3-tetramethyldisiloxane; 1,1,3,3-tetraethyldisiloxane; 1,1,3,3-tetra-n-propyldisiloxane; 1,1,3,3-tetraisopropyldisiloxane; 1,1,3,3-tetra-n-butyldisiloxane; 1,1,3,3-tetraisobutyldisiloxane; 1,1,3,3-tetra-sec-butyldisiloxane; 1,1,3,3-tetra-tert-butyldisiloxane; 1,1,3,3-tetracyclopentyldisiloxane; 1,1,3,3-tetracyclohexyldisiloxane; 1,3-diethyl-1,3-dimethyldisiloxane; 1,3-dimethyl-1,3-di-n-propyldisiloxane; 1,3-dimethyl-1,3-diisopropyldisiloxane; 1,3-di-n-butyl-1,3-dimethyldisiloxane; 1,3-diisobutyl-1,3-dimethyldisiloxane; 1,3-di-sec-butyl-1,3-dimethyldisiloxane; 1,3-di-tert-butyl-1,3-dimethyldisiloxane; 1,3-dicyclopentyl-1,3-dimethyldisiloxane; 1,3-dicyclohexyl-1,3-dimethyldisiloxane; 1,3-diethyl-1,3-di-n-propyldisiloxane; 1,3-diethyl-1,3-diisopropyldisiloxane; 1,3-di-n-butyl-1,3-diethyldisiloxane; 1,3-diisobutyl-1,3-diethyldisiloxane; 1,3-di-sec-butyl-1,3-diethyldisiloxane; 1,3-di-tert-butyl-1,3-diethyldisiloxane; 1,3-dicyclopentyl-1,3-diethyldisiloxane; and, 1,3-dicyclohexyl-1,3-diethyldisiloxane.

The siloxanes of the general Formula (II) may be commercial products or can be prepared by processes known in organosilicon chemistry. For example, the dihydrotetra(organyl)siloxanes are obtainable by hydrolysis of halodi(organyl)-H-silanes. Said halodi(organyl)-H-silanes are themselves either commercially available products or are obtainable by, for example: the direct synthesis of silicon with haloorganyls following the Müller-Rochow process; and, salt elimination reactions of metal organyls—such as Grignard reagents or lithium organyls— with dihalo(organyl)silanes.

### Process Conditions

The hydroxyalkyl-allyl ether of Formula (I) and the siloxane of Formula (II) are generally reacted such that the molar ratio of said adduct to said siloxane is equal or higher than 2:1. The reaction can be carried out under atmospheric or elevated pressure. Further, the reaction can be carried out at a temperature from 25 to 250° C. and preferably from 70 to 200° C. And in carrying out the reaction, organic solvents may or may not be used but, when employed, solvents such as toluene, xylene, heptane, dodecane, ditolylbutane, cumene and mixtures thereof are preferred.

The reaction is performed under anhydrous conditions and in the presence of a catalyst. The catalyst used is a transition metal catalyst of which the transition metal is selected from Groups 8 to 10 of the Periodic Table and more usually from the group consisting of ruthenium, rhodium, palladium, osmium, iridium, platinum and combinations thereof.

As illustrative but non-limiting examples of such catalysts may be mentioned: platinum catalysts, such as platinum black powder, platinum supported on silica powder, platinum supported on alumina powder, platinum supported on carbon powder (e.g., activated carbon), chloroplatinic acid, 1,3-divinyltetramethyldisiloxane complexes of platinum, carbonyl complexes of platinum and olefin complexes of platinum; palladium catalysts, such as palladium supported on silica powder, palladium supported on alumina powder, palladium supported on carbon powder (e.g., activated carbon), carbonyl complexes of palladium and olefin complexes of palladium; ruthenium catalysts, such as RhCl₃(Bu₂S)₃, ruthenium 1,3-ketoenolate and ruthenium carbonyl compounds such as ruthenium 1,1,1-trifluoroacetylacetonate, ruthenium acetylacetonate and triruthinium dodecacarbonyl; and, rhodium catalysts, such as rhodium supported on silica powder, rhodium supported on alumina powder, rhodium supported on carbon powder (e.g., activated carbon), carbonyl complexes of rhodium and olefin complexes of rhodium. Preferred catalysts take the form of said transition metals supported on a powder such as alumina, silica, or carbon; platinum supported on carbon powder is particularly preferred for use as the catalyst in the present method.

Without intention to limit the catalytic amount of the transition metal catalysts used in step i) of the present method, typically the catalyst is used in an amount that provides from 0.0001 to 1 gram of catalytic metal per equivalent of silicon-bonded hydrogen in the siloxane.

The progress of the reaction and, in particular, the consumption of the unsaturated group of the hydroxyalkyl allyl ether can be monitored by known methods. This aside, the reaction generally requires a time of 0.5 to 72 hours to reach completion, more commonly from 1 to 30 or 1 to 20 hours.

Upon completion of the reaction, it is facile to remove any solid, suspended compounds by, for example, filtration, crossflow filtration or centrifugation. Further, the reaction product may be worked up, using methods known in the art, to isolate and purify the reaction product. For example, any solvent present may be removed by stripping at reduced pressure.

### Preparation of Dicarbinol Silicone Polymer—Step ii

In a reaction vessel which is capable of imparting shear to the contents thereof and under polymerization conditions, the reaction product of step i) is reacted with at least one cyclic siloxane. Some useful cyclic siloxanes have the structure of general Formula (III) as described herein below:

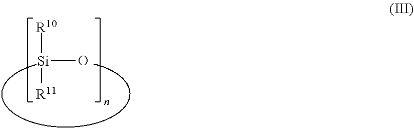

wherein n is 3, 4, 5, 6, 7 or 8, preferably 4; R¹⁰ and R¹¹ may be the same or different and each is independently selected from hydrogen, a C₁-C₈ alkyl group, a C₂-C₈ alkenyl group, a C₃-C₁₀ cycloalkyl group, a C₆-C₁₈ aryl group or a C₆-C₁₈ aralkyl group.

Mixtures of co-polymerizable cyclic siloxane monomers can also be used in step ii. Further, while suitable cyclic siloxane monomers will generally contain “n” identical R¹⁰ groups and “n” identical R¹¹ groups, the R¹⁰ and R¹¹ groups attached to a given silicon atom need not necessarily be the same as those attached to an adjacent silicon atom. For example, the monomers [(C₂H₅)(C₆H₅)SiO]₂[(C₂H₅)₂SiO] and [(C₂H₅)(C₆H₅)SiO][(C₂H₅)₂]SiO]₂ are considered monomers within the terms of Formula (III).

In an embodiment, each R¹⁰ and R¹¹ may independently represent a C₁-C₈ alkyl group. An exemplary, but not limiting list of cyclic siloxanes of meeting this embodiment of Formula (III) includes: [(CH₃)₂SiO]₈; [(CH₃)₂SiO]₇; [(CH₃)₂SiO]₆; decamethylcyclopentasiloxane (D₅); octamethylcyclotetrasiloxane (D₄); hexamethylcyclotrisiloxane (D₃); [(CH₃)(C₂H₅)SiO]₃; [(CH₃)(C₂H₅)SiO]₄; [(CH₃)(C₂H₅)SiO]₅; [(CH₃)(C₂H₅)SiO]₆; [(C₂H₅)₂SiO]₃; [(C₂H₅)₂SiO]₄; and, [(C₂H₅)₂SiO]₅. Within said embodiment, it is preferred that R¹⁰ and R¹¹ are the same. More particularly, it is preferred that R¹⁰ and R¹¹ of the cyclic siloxanes of Formula (III) are both methyl (C₁).

Good results have, for instance, been obtained when the cyclic siloxane of Formula (III) is octamethylcyclotetrasiloxane (D4).

Further useful cyclic siloxane monomers of Formula (III) include: octaphenylcyclotetrasiloxane; tetramethylcyclotetrasiloxane; tetramethyltetravinylcyclotetrasiloxane; [(C₆H₅)₂SiO]₃; [(C₂H₅)(C₆H₅)SiO]₃; and, [(C₂H₅)(C₆H₅)SiO]₄.

While there is not specific intention to limit the mechanism of ring opening polymerization employed in the present invention and while therefore ring opening polymerization of cyclic siloxane monomers by the anionic route, via basic catalysts is not strictly precluded, it is preferred herein for said polymerization to proceed by a cationic route, via acid catalysis. Broadly, any suitable acidic ring opening polymerization catalyst may be utilized herein and, equally, mixtures of catalysts may be employed, Both Lewis and Bronsted acids may be suitable in this context, but the latter are preferred as they tend to be effective at temperatures of less than 150° C. and are usually effective at temperatures of from 50 to 100° C.

Examples of suitable Lewis acids include but are not limited to: BF₃; AlCl₃; t-BuCl/Et₂AlCl; Cl₂/BCl₃; AlBr₃; AlBr₃.TiCl₄; I₂; SbCl₅; WCl₆; AlEt₂Cl; PF₅; VCl₄; AlEtCl₂; BF₃Et₂O; PCl₅; PCl₃; POCl₃; TiCl₃; and, SnCl₄.

Examples of Bronsted acid or proton acid type catalysts—which may optionally be disposed on solid, inorganic supports—include, but are not limited to: HCl; HBr; HI; H₂SO₄; HClO₄; para-toluenesulfonic acid; trifluoroacetic acid; and, perfluoroalkane sulfonic acids, such as trifluoromethane sulfonic acid (or triflic acid, CF₃SO₃H), C₂F₅SO₃H, C₄F₉SO₃H, C₅F₁₁SO₃H, C₆F₁₃SO₃H and C₈F₁₇SO₃H. The most preferred of these strong acids is trifluoromethane sulfonic acid (triflic acid, CF₃SO₃H).

The catalysts for said ring opening polymerization may usually be employed at a concentration of from 1 to 1000 ppm by weight based on the total weight of the cyclic siloxane monomers to be polymerized. Preferably from 5 to 150 ppm by weight are used, most preferably from 5 to 50 ppm. The catalytic amount may be reduced when the temperature at which the monomers and the catalyst are contacted is increased.

The ring opening polymerization may conveniently be carried out at a temperature in the range from 10 to 150° C. Preferably, however, the temperature range is from 20 or 50 to 100° C. as obviating high temperatures can limit the loss of volatile cyclic siloxanes from the reaction mixture due to their lower boiling point.

The process pressure is not critical. As such, the polymerization reaction can be run at sub-atmospheric, atmospheric, or super-atmospheric pressures but pressures at or above atmospheric pressure are preferred.

The reaction should be performed under anhydrous conditions and in the absence of any compound having an active hydrogen atom. Exposure to atmospheric moisture may be avoided by providing the reaction vessel with an inert, dry gaseous blanket. While dry nitrogen and argon may be used as blanket gases, precaution should be used when common nitrogen gas is used as a blanket, because such nitrogen may not be dry enough on account of its susceptibility to moisture entrainment; the nitrogen may require an additional drying step before its use herein.

The duration of the reaction is dependent on the time taken for the system to reach equilibrium. Equally, however, it is understood that the desired product can be obtained by stopping the equilibration at exactly the desired time: for example, the reaction can be monitored by analyzing viscosity over time or by analyzing monomer conversion using gas chromatography and the reaction stopped when the desired viscosity or monomer conversion is attained. These considerations aside, the polymerization reaction generally takes place for from 0.5 to 72 hours and more commonly from 1 to 30 or 1 to 20 hours. Acid catalysts present in the reaction mixture at the end of the polymerization reaction can easily be neutralized in order to stabilize the reaction product.

Upon completion of the polymerization, it is possible to remove any solid, suspended compounds by, for example, filtration, crossflow filtration or centrifugation. Further, the output of the polymerization may be worked up, using methods known in the art, to isolate and purify the hydroxyl-functionalized polysiloxanes. Mention in this regard may be made of extraction, evaporation, distillation and chromatography as suitable techniques. Upon isolation, it has been found that typical yields of the hydroxyl-functionalized polysiloxanes are at least 40% and often at least 60%.

The hydroxyl-functionalized polysiloxanes disclosed herein invention may possess a molecular weight (Mn) of from 500 to 150000 g/mol, preferably from 5000 to 100000, more preferably from 10000 to 100000. Moreover, the polymers may be characterized by a polydispersity index in the range from 1.0 to 5.0, preferably from 1.0 to 2.5.

Preparation of curable, (meth)acrylate terminated polysiloxane polymer The dicarbinol silicone polymer is reacted with a (meth)acrylate terminated isocyanate to form the final diacrylate terminated silicone polymer.

Useful (meth)acrylate terminated isocyanate reactants are not limited and include mono and polyisocyanates comprising (meth)acrylate functionality. Useful (meth)acrylate terminated isocyanate reactants include those of Formula VI:

OCN—B—C(O)—C(R)═CH₂ (VI)

wherein B can be alkylene, heteroalkylene, polyether and combinations thereof. In some embodiments B is —[CH₂]ₚ—[ZO]ₓ— where Z is alkyl, p is 0 to 10, preferably 2 or 3 and x is 0 to 10. In one embodiment B is -[alkyl-O—]ₚ and p is 1 to 10. Some exemplary (meth)acrylate terminated isocyanate reactants include acryloxyethylisocyanate (AOI) and methacryloxyethylisocyanate (MOI).

The stoichiometric ratio of NCO groups of the (meth)acrylate terminated isocyanate with respect to OH groups of the dicarbinol silicone polymer is chosen to provide a desired functionality. A theoretical ratio of 1 NCO group to 1 OH group will provide a diacrylate terminated silicone polymer.

Reaction of the (meth)acrylate terminated isocyanate reactant with the dicarbinol silicone polymer is typically performed under anhydrous conditions, elevated temperatures and in the presence of a polyurethane catalyst. Useful temperatures for this reaction range from room temperature to 160° C.

In principle, any compound that can catalyze the reaction of a hydroxyl group and an isocyanato group to form a urethane bond can be used. Some useful examples include: tin carboxylates such as dibutyltin dilaurate (DBTL), dibutyltin diacetate, dibutyltin diethylhexanoate, dibutyltin dioctoate, dibutyltin dimethylmaleate, dibutyltin diethylmaleate, dibutyltin dibutylmaleate, dibutyltin diiosooctylmaleate, dibutyltin ditridecylmaleate, dibutyltin dibenzylmaleate, dibutyltin maleate, dibutyltin diacetate, tin octaoate, dioctyltin distearate, dioctyltin dilaurate (DOTL), dioctyltin diethylmaleate, dioctyltin diisooctylmaleate, dioctyltin diacetate, and tin naphthenoate; tin alkoxides such as dibutyltin dimethoxide, dibutyltin diphenoxide, and dibutyltin diisoproxide; tin oxides such as dibutyltin oxide and dioctyltin oxide; reaction products between dibutyltin oxides and phthalic acid esters; dibutyltin bisacetylacetonate; titanates such as tetrabutyl titanate and tetrapropyl titanate; organoaluminum compounds such as aluminum trisacetylacetonate, aluminum trisethylacetoacetate, and diisopropoxyaluminum ethylacetoacetate; chelate compounds such as zirconium tetraacetylacetonate and titanium tetraacetylacetonate; lead octanoate; amine compounds or salts thereof with carboxylic acids, such as butylamine, octylamine, laurylamine, dibutylamines, monoethanolamines, diethanolamines, triethanolamine, diethylenetriamine, triethylenetetramine, oleylamines, cyclohexylamine, benzylamine, diethylaminopropylamine, xylylenediamine, triethylenediamine, guanidine, diphenylguanidine, 2,4,6-tris(dimethylaminomethyl)phenol, 2,2′-dimorpholinodiethylether, triethylenediamine, morpholine, N-methylmorpholine, 2-ethyl-4-methylimidazole and 1,8-diazabicyclo-(5,4,0)-undecene-7 (DBU); aliphatic carboxylate salts or acetylacetonates of potassium, iron, indium, zinc, bismuth, or copper.

The catalyst is preferably present in an amount of from 0.005 to 3.5 wt. % based on the total composition weight.

Preparation of curable (meth)acrylate terminated polysiloxane polymer by reaction of one or more cyclic siloxanes and one or more dimethacrylate siloxane(s).

In another embodiment one or more cyclic siloxane(s) is(are) reacted with one or more dimethacrylate siloxane(s) to form a diacrylate terminated silicone polymer. Useful cyclic siloxanes for this embodiment are disclosed above. Useful dimethacrylate siloxanes include those having a MA-R—[Si(CH₃)(CH₃)—O]ₙ—Si(CH₃)(CH₃)—R-MA structure wherein each MA is independently a (meth)acrylate group, each R is independently an alkylene group and preferably a C₁-C₈ alkylene group and more preferably a C₁-C₃ alkylene group, and n is 1, 2, 3, 4 or 5, preferably 1. Examples of useful dimethacrylate siloxanes include Gelest 1402.0 available from Gelest Inc. and X-22-164 available from ShinEtsu.

The cyclic siloxane and the dimethacrylate siloxane are generally reacted such that the molar ratio of cyclic siloxane to dimethacrylate siloxane is 1 to 5000. The reaction can be carried out under atmospheric or elevated pressure. Further, the reaction can be carried out at a temperature from 25 to 250° C. and preferably from 70 to 200° C. And in carrying out the reaction, organic solvents may or may not be used but, when employed, solvents such as toluene, xylene, heptane, dodecane, ditolylbutane, cumene and mixtures thereof are preferred. Ring opening catalysts as disclosed above can be used in the reaction. Radical polymerization inhibitors such as hydroquinone monomethyl ether (MEHQ) can be used to moderate and inhibit the reaction.

The duration of the reaction is dependent on the time taken for the system to reach equilibrium. Equally, however, it is understood that the desired product can be obtained by stopping the equilibration at exactly the desired time: for example, the reaction can be monitored by analyzing viscosity over time or by analyzing monomer conversion using gas chromatography and the reaction stopped when the desired viscosity or monomer conversion is attained. These considerations aside, the polymerization reaction generally takes place for from 0.5 to 72 hours and more commonly from 1 to 20 or 1 to 10 hours or 1 to 5 hours. Acid catalysts present in the reaction mixture at the end of the polymerization reaction can easily be neutralized in order to stabilize the reaction product.

Preparation of curable (meth)acrylate terminated polysiloxane polymer by reaction of an amine terminated siloxane and a (meth)acrylate terminated isocyanate. In another embodiment one or more amine terminated siloxane(s) is(are) reacted with one or more (meth)acrylate isocyanate to form a diacrylate terminated silicone polymer. Useful amine terminated siloxanes for this embodiment include those having a AM-R—[Si(CH₃)(CH₃)—O]ₙ—Si(CH₃)(CH₃)—R-AM structure wherein each AM is independently an —NX₁X₂ group where X₁ and X₂ each independently comprise H or alkyl with the proviso that at least one of X₁ and X₂ is H and preferably both of X₁ and X₂ are H; each R is independently an alkylene group and preferably a C₁-C₈ alkylene group and more preferably a C₁-C₃ alkylene group, and n is 1 to 20000. Examples of useful amine terminated siloxanes include aminopropyl terminated polydimethylsiloxane sold under the name DMS-A35 available from Gelest Inc. and metharyl-modified silicone fluids sold by ShinEtsu.

Useful (meth)acrylate terminated isocyanates are disclosed above in Formula VI. Some exemplary (meth)acrylate terminated isocyanate reactants include acryloxyethylisocyanate (AOI) and methacryloxyethylisocyanate (MOI).

The stoichiometric ratio of NCO groups of the (meth)acrylate terminated isocyanate with respect to amine groups of the amine terminated siloxane is chosen to provide a desired functionality. A theoretical ratio of 1 NCO group to 1 amine group will provide a diacrylate terminated silicone polymer.

Reaction of the (meth)acrylate terminated isocyanate reactant with the amine terminated siloxane is typically performed under anhydrous conditions, elevated temperatures and in the presence of a polyurethane catalyst. Useful temperatures for this reaction range from room temperature to 160° C.

In principle, any compound that can catalyze the reaction of an amine group and an isocyanato group to form a urethane bond can be used. Some useful examples of urethane catalysts are disclosed above. The catalyst is preferably present in an amount of from 0.005 to 3.5 wt. % based on the total composition weight.

The duration of the reaction is dependent on the time taken for the system to reach equilibrium. Equally, however, it is understood that the desired product can be obtained by stopping the equilibration at exactly the desired time: for example, the reaction can be monitored by analyzing isocyanate content and the reaction stopped when the desired urethane conversion is attained. These considerations aside, the polymerization reaction generally takes place for from 0.5 to 72 hours and more commonly from 1 to 20 or 1 to 10 hours or 1 to 5 hours.

Preparation of curable (meth)acrylate terminated polysiloxane polymer by reaction of an amine terminated siloxane and an acrylic acid chloride.

In another embodiment one or more amine terminated siloxane(s) is(are) reacted with one or more acrylic acid chlorides to form a diacrylate terminated silicone polymer. Useful amine terminated siloxanes are disclosed above. Some exemplary acrylic acid chlorides include (meth)acrylate chlorides, 2-propenoyl chloride or acryloyl chloride.

The stoichiometric ratio of acryloyl groups of the acrylic acid chloride with respect to amine groups of the amine terminated siloxane is chosen to provide a desired functionality. A theoretical ratio of 1 acryloyl group to 1 amine group will provide a diacrylate terminated silicone polymer.

The reaction can be carried out under atmospheric or elevated pressure. The reaction is typically carried out below room temperature, for example at a temperature from 0 to 40° C. and preferably from 0 to 25° C. And in carrying out the reaction, organic solvents may or may not be used but, when employed, solvents such as toluene, xylene, heptane, dodecane, ditolylbutane, cumene and mixtures thereof are preferred. A base such as triethylamine can be used to remove hydrogen chloride formed during the reaction. Polymerization inhibitors such as hydroquinone monomethyl ether (MEHQ) can be used to moderate and inhibit the reaction.

The duration of the reaction is dependent on the time taken for the system to reach equilibrium. Equally, however, it is understood that the desired product can be obtained by stopping the equilibration at exactly the desired time: for example, the reaction can be monitored by analyzing isocyanate content and the reaction stopped when the desired urethane conversion is attained. These considerations aside, the polymerization reaction generally takes place for from 0.5 to 72 hours and more commonly from 1 to 20 or 1 to 10 hours or 1 to 5 hours.

Compositions and Applications of the radiation curable, (meth)acrylate terminated polysiloxane polymers.

The disclosed curable, (meth)acrylate terminated polysiloxane polymer is useful as a curable, crosslinkable or otherwise reactive component of a coating composition, a sealant composition or an adhesive composition. A curable composition, such as a coating, sealant or adhesive composition comprising the radiation curable, (meth)acrylate terminated polysiloxane polymer can optionally comprise 0 wt. % to more than 98 wt. % of one or more adjuvants and additives that can impart improved properties to these compositions. For instance, the adjuvants and additives may impart one or more of: improved elastic properties; improved elastic recovery; longer enabled processing time; faster curing time; and, lower residual tack. Included among such adjuvants and additives are catalysts, crosslinkers, radiation initiators, heat cure initiators, plasticizers, stabilizers, antioxidants, fillers, reactive diluents, drying agents, adhesion promoters and UV stabilizers, fungicides, flame retardants, rheological adjuvants, color pigments or color pastes, and/or optionally also, to a small extent, solvents.

The curable compositions can optionally comprise one or more plasticizers. A “plasticizer” is a substance that decreases the viscosity of the composition and thus facilitates its processability. Herein the plasticizer may constitute 0 wt. % up to 40 wt. % or 0 wt. % up to 20 wt. %, based on the total weight of the composition, and is preferably selected from the group consisting of: polydimethylsiloxanes (PDMS); diurethanes; ethers of monofunctional, linear or branched C₄-C₁₆ alcohols, such as Cetiol OE (obtainable from Cognis Deutschland GmbH, Düsseldorf); esters of abietic acid, butyric acid, thiobutyric acid, acetic acid, propionic acid esters and citric acid; esters based on nitrocellulose and polyvinyl acetate; fatty acid esters; dicarboxylic acid esters; esters of OH-group-carrying or epoxidized fatty acids; glycolic acid esters; benzoic acid esters; phosphoric acid esters; sulfonic acid esters; trimellitic acid esters; epoxidized plasticizers; polyether plasticizers, such as end-capped polyethylene or polypropylene glycols; polystyrene; hydrocarbon plasticizers; chlorinated paraffin; and, mixtures thereof. It is noted that, in principle, phthalic acid esters can be used as the plasticizer but these are not preferred due to their toxicological potential. It is preferred that the plasticizer comprises or consists of one or more polydimethylsiloxane (PDMS).

The curable compositions can optionally comprise one or more stabilizers. A “stabilizer” can be one or more of antioxidants, UV stabilizers or hydrolysis stabilizers. Stabilizers may constitute in toto 0 wt. % up to 10 wt. % or 0 wt. % up to 5 wt. %, based on the total weight of the composition. Standard commercial examples of stabilizers suitable for use herein include sterically hindered phenols and/or thioethers and/or substituted benzotriazoles and/or amines of the hindered amine light stabilizer (HALS) type. It is preferred in the context of the present invention that a UV stabilizer that carries a silyl group—and becomes incorporated into the end product upon crosslinking or curing—be used: the products Lowilite™ 75, Lowilite™ 77 (Great Lakes, USA) are particularly suitable for this purpose. Benzotriazoles, benzophenones, benzoates, cyanoacrylates, acrylates, sterically hindered phenols, phosphorus and/or sulfur can also be added.

The curable compositions can optionally comprise one or more photoinitiators. Photoinitiators will initiate and/or accelerate crosslinking and curing of the curable (meth)acrylate terminated polysiloxane polymer and a composition comprising the same when exposed to actinic radiation such as, for example, UV radiation. Useful, non-limiting examples of photoinitiators include, one or more selected from the group consisting of benzyl ketals, hydroxyl ketones, amine ketones and acylphosphine oxides, such as 2-hydroxy-2-methyl-1-phenyl-1-acetone, diphenyl (2,4,6-triphenylbenzoyl)-phosphine oxide, 2-benzyl-dimethylamino-1-(4-morpholinophenyl)-butan-1-one, benzoin dimethyl ketal dimethoxy acetophenone, a-hydroxy benzyl phenyl ketone, 1-hydroxy-1-methyl ethyl phenyl ketone, oligo-2-hydoxy-2-methyl-1-(4-(1-methylvinyl)phenyl)acetone, benzophenone, methyl o-benzyl benzoate, methyl benzoylformate, 2-diethoxy acetophenone, 2,2-disec-butoxyacetophenone, p-phenyl benzophenone, 2-isopropyl thioxanthenone, 2-methylanthrone, 2-ethylanthrone, 2-chloroanthrone, 1,2-benzanthrone, benzoyl ether, benzoin ether, benzoin methyl ether, benzoin isopropyl ether, α-phenyl benzoin, thioxanthenone, diethyl thioxanthenone, 1,5-acetonaphthone, 1-hydroxycyclohexylphenyl ketone, ethyl p-dimethylaminobenzoate. These photoinitiators may be used individually or in combination which each other. The curable compositions may further comprise 0 wt. % up to 5 wt. %, for example from 0.01 to 3 wt. %, based on the total weight of the composition, of photoinitiator.

The curable compositions can optionally comprise one or more heat cure initiators. Heat cure initiators comprise an ingredient or a combination of ingredients which at the desired elevated temperature conditions will initiate and/or accelerate crosslinking and curing of a composition. Useful, non-limiting examples of heat cure initiators include peroxy materials, e.g., peroxides, hydroperoxides, and peresters, which under appropriate elevated temperature conditions decompose to form peroxy free radicals which are initiatingly effective for the polymerization of the curable compositions. The peroxy materials may be employed in concentrations effective to initiate curing of the curable composition at a desired temperature and typically in concentrations of about 0.1% to about 10% by weight of composition. Another useful class of heat-curing initiators comprises azonitrile compounds, such as described in U.S. Pat. No. 4,416,921, the disclosure of which is incorporated herein by reference. Azonitrile initiators are commercially available, e.g., the initiators which are commercially available under the trademark VAZO from E. I. DuPont de Nemours and Company, Inc., Wilmington, Del.

The curable compositions can optionally comprise one or more fillers. Some suitable fillers include, for example, chalk, lime powder, precipitated and/or pyrogenic silicic acid, zeolites, bentonites, magnesium carbonate, diatomite, alumina, clay, talc, titanium oxide, iron oxide, zinc oxide, sand, quartz, flint, mica, glass powder, and other ground mineral substances. Organic fillers can also be used, in particular carbon black, graphite, wood fibers, wood flour, sawdust, cellulose, cotton, pulp, cotton, wood chips, chopped straw, chaff, ground walnut shells, and other chopped fibers. Short fibers such as glass fibers, glass filament, polyacrylonitrile, carbon fibers, Kevlar fibers, or polyethylene fibers can also be added. Aluminum powder is likewise suitable as a filler.

The pyrogenic and/or precipitated silicic acids advantageously have a BET surface area from 10 to 90 m²/g. When they are used, they do not cause any additional increase in the viscosity of the composition according to the present invention, but do contribute to strengthening the cured composition.

It is likewise conceivable to use pyrogenic and/or precipitated silicic acids having a higher BET surface area, advantageously from 100 to 250 m²/g, in particular from 110 to 170 m²/g, as a filler because of the greater BET surface area, the effect of strengthening the cured composition is achieved with a smaller proportion by weight of silicic acid.

Also suitable as fillers are hollow spheres having a mineral shell or a plastic shell. These can be, for example, hollow glass spheres that are obtainable commercially under the trade names Glass Bubbles®. Plastic-based hollow spheres, such as Expancel® or Dualite®, may be used and are described in EP 0 520 426 B1: they are made up of inorganic or organic substances and each have a diameter of 1 mm or less, preferably 500 μm or less.

The total amount of fillers present in the compositions will preferably be from 0 wt. % to 80 wt. %, and more preferably from 5 to 60 wt. %, based on the total weight of the composition. The desired viscosity of the curable composition will typically be determinative of the total amount of filler added and it is submitted that in order to be readily extrudable out of a suitable dispensing apparatus—such as a tube—the curable compositions should possess a viscosity at room temperature of from 3000 to 150,000 mPas, preferably from 40,000 to 80,000 mPas, or even from 50,000 to 60,000 mPas.

The curable compositions can optionally comprise one or more colorants such as dye or pigment. Examples of suitable colorants include fluorescent dye, titanium dioxide, iron oxides, or carbon black.

In order to enhance shelf life even further, it is often advisable to further stabilize the compositions of the present invention with respect to moisture penetration through using drying agents. If used, the proportion of moisture scavenger or drying agent in the composition is about 0 wt. % to 10 wt. % and preferably about 1 wt. % to about 2 wt. %, based on the total weight of the composition. Useful moisture scavengers include vinyl silane-trimethoxyvinylsilane (VTMO).

The curable compositions can optionally comprise one or more reactive diluents. Reactive diluents can lower the viscosity of an adhesive or sealant composition for specific applications. The total amount of reactive diluents present will typically be 0 wt. % up to 15 wt. %, and preferably from 1 and 5 wt. %, based on the total weight of the composition.

The curable compositions can optionally comprise one or more rheological adjuvants. Rheological adjuvants impart thixotropy to the composition and include, for example, hydrogenated castor oil, fatty acid amides, or swellable plastics such as PVC. The total amount of rheological adjuvants present will typically be 0 wt. % up to 15 wt. %, and preferably from 1 and 5 wt. %, based on the total weight of the composition. All compounds that are miscible with the composition and provide a reduction in viscosity and that possess at least one group that is reactive or can form bonds with the composition can be used as reactive diluents. Reactive diluents typically have a viscosity of 5 cP to 3,000 cP at room temperature. Reactive diluents can comprise mono-functional (meth)acrylates, (meth)acrylamides, (meth)acrylic acid and combinations thereof. Illustrative examples of useful mono-functional (meth)acrylates, include alkyl (meth)acrylates, cycloalkyl (meth)acrylates, alkenyl (meth)acrylates, heterocycloalkyl (meth)acrylates, heteroalkyl methacrylates, alkoxy polyether mono(meth)acrylates.

The alkyl group on the (meth)acrylate desirably may be a substituted or unsubstituted alkyl group having 1 to 20 carbon atoms, desirably 1 to 10 carbon atoms, optionally having at least one substituent selected from an alkyl group having 1 to 10 carbon atoms, substituted or unsubstituted cycloalkyl group having 1 to 20 carbon atoms, desirably 1 to 10 carbon atoms, substituted or unsubstituted bicyclo or tricycloalkyl group having 1 to 20 carbon atoms, desirably 1 to 15 carbon atoms, an alkoxy group having 1 to 10 carbon atoms, an aryloxy group having 6 to 10 carbon atoms.

The alkenyl group on the (meth)acrylate desirably may be a substituted or unsubstituted alkenyl group having 2 to 20 carbon atoms, desirably 2 to 10 carbon atoms, optionally having at least one substituent selected from an alkyl group having 1 to 10 carbon atoms, an alkoxy group having 1 to 10 carbon atoms, an aryloxy group having 6 to 10 carbon atoms, an epoxy group having 2 to 10 carbon atoms, hydroxyl and the like.

The heterocyclo group on the (meth)acrylate desirably may be a substituted or unsubstituted heterocyclo group having 2 to 20 carbon atoms, desirably 2 to 10 carbon atoms, containing at least one hetero atom selected from N and O, and optionally having at least one substituent selected from an alkyl group having 1 to 10 carbon atoms, an alkoxy group having 1 to 10 carbon atoms, an aryloxy group having 6 to 10 carbon atoms, or an epoxy group having 2 to 10 carbon atoms.

The alkoxy polyether mono(meth)acrylates can be substituted with an alkoxy group having 1 to 10 carbons and the polyether can have 1 to 10 repeat units.

Some exemplary mono-functional (meth)acrylate reactive diluents include, but are not limited to, methyl (meth)acrylate, ethyl (meth)acrylate, butyl (meth)acrylate, tetrahydrofuryl (meth)acrylate, lauryl acrylate, isooctyl acrylate, isodecyl acrylate, 2-ethylhexyl acrylate, isobornyl (meth)acrylate, dicyclopentenyl (meth)acrylate, octadecyl acrylate, 2-hydroxyethyl (meth)acrylate, 2-hydroxypropyl (meth)acrylate, 2-hydroxybutyl (meth)acrylate, 2-(2-ethoxyethoxy)ethyl acrylate, 2-phenoxyethyl acrylate, dicyclopentadienyl (meth)acrylate, dicyclopentenyloxyethyl (meth)acrylate, morpholine (meth)acrylate, isobornyl (meth)acrylate, N,N,dialkyl acrylamide, 2-methoxyethyl (meth)acrylate, 2(2-ethoxy)ethoxy ethyl acrylate and caprolactone acrylate.

Some exemplary (meth)acrylamides may be unsubstituted (meth)acrylamides, N-alkyl substituted (meth)acrylamides or N,N-dialkyl substituted (meth)acrylamides. In the N-alkyl substituted (meth)acrylamides, the alkyl substituent desirably has 1 to 8 carbon atoms, such as N-ethyl acrylamide, N-octyl acrylamide and the like. In the N,N-dialkyl substituted (meth)acrylamides, the alkyl substituent desirably has 1 to 4 carbon atoms, such as N,N-dimethyl acrylamide and N,N-diethyl acrylamide.

The organic diluent is desirably a low viscosity liquid that is compatible with silicone hybrid polymer at normal temperature. The term “normal temperature” or “room temperature” means about 25° C.

The curable compositions can optionally comprise one or more crosslinkers. Crosslinkers are compounds having two or three functional groups that reactive with other components of the composition. Compounds having four or more compositionally reactive functional groups are preferably not used in the disclosed compositions. Crosslinkers will typically have a molecular weight of 10,000 g/mol or 5,000 g/mol or less or 1,000 g/mol or less. The total amount of crosslinkers present will typically be 0 wt. % up to 50 wt. %, and preferably from 5 to 40 wt. %, based on the total weight of the composition.

The curable compositions can optionally comprise one or more additional polymers or prepolymers or oligomers having a molecular weight of 5,000 or more. Additional polymers or pre-polymers can be selected in this context from polyesters, polyoxyalkylenes, polyacrylates, polymethacrylates, polydialkylsiloxanes or mixtures thereof. Additional polymers or pre-polymers can be reactive with the composition or non-reactive with the composition. The total amount of additional polymers or pre-polymers present can be 0 wt. % up to 90 wt. %, for example from 0 to 80 wt. %, and preferably 0 wt. % to 70 wt % and more preferably 0 wt. % to 40 wt. % based on the total weight of the composition.

The adhesive composition according to the disclosure can optionally comprise one or more adhesion promoters. An adhesion promoter is a substance which improves the adhesion properties of the composition to a surface. It is possible to use conventional adhesion promoters known to the person skilled in the art individually or in combination. Examples of suitable adhesion promoters include organo-silanes such as amino silanes, epoxy silanes and oligomeric silane compounds. The adhesion promoter, if more reactive than the silane-functional polymer with moisture, can also serve as a moisture scavenger. One or more adhesion promoter(s) is/are preferably contained in the curable composition according to the disclosure in a quantity of 0 to 5 wt. %, more preferably 0.2 to 2 wt. %, in particular 0.3 to 1 wt. %, based in each case on the total weight of the composition.

Various features and embodiments of the disclosure are described in the following examples, which are intended to be representative and not limiting.

### EXAMPLES

### Example 1: Synthesis of Radiation Curable, (Meth)Acrylate Terminated Polysiloxane Polymer 1

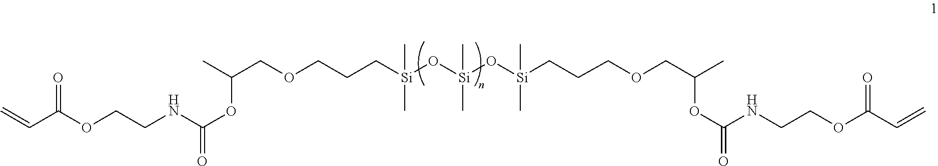

To a 500 mL reactor was added octamethylcyclotetrasiloxane (D4) 200 g, 2-hydoxypropoxy-ethyl disiloxane 9.0 g and trifluoromethanesulfonic acid 100 μL. The reaction mixture was heated up to 90° C. with an agitation rate at 150 rpm, and stir at 90° C. for additional 2 hours. Sodium bicarbonate (NaHCO3) 3.2 g was then added to neutralize the acid. The reaction mixture was mixed at 90° C. for another 30 min before cooling down. The reaction mixture was filtered through a 2 micron filter pad and followed with vacuum stripping to obtain the di-carbinol silicone polymer. GPC analysis (PS standard): Mw 21969, Mn 12290, Mp 22145, PDI 1.79.

To a 500 ml reactor was added the carbinol silicone polymer (Mw 21969) 128.9. The reactor was then placed into a 55° C. bath, and vacuumed at 3 mbar for 2 hours with stir. After the vacuum, the reactor was refilled with dry N2 gas. Reaxis 216 0.0176 g was added at this temperature, and stirred for 10 min before acryloxyethylisocyanate (A01) 3.13 g was added. The mixture was stirred for additional 2 hours. VTMO 2.60 g was then added and mixed for 10 min before cooling down to obtain the silicone diacrylate polymer.

### Example 2: Synthesis of Radiation Curable, (Meth)Acrylate Terminated Polysiloxane Polymer 2

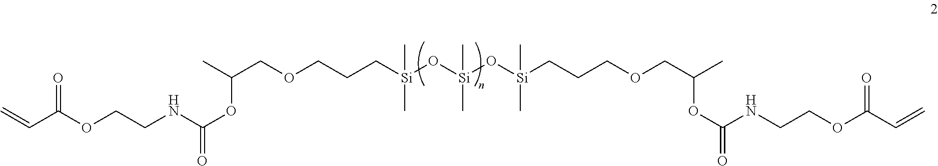

To a 1 L reactor was added octamethylcyclotetrasiloxane (D4) 835.1 g, 2-hydoxypropoxy-ethyl disiloxane 15.5 g and trifluoromethanesulfonic acid 418 μL. The reaction mixture was heated up to 90° C. with an agitation rate at 150 rpm, and stir at 90° C. for additional 2 hours. Sodium bicarbonate (NaHCO3) 6.7 g was then added to neutralize the acid. The reaction mixture was mixed at 90° C. for another 30 min before cooling down. The reaction mixture was filtered through a 2 micron filter pad and followed with vacuum stripping to obtain the di-carbinol silicone polymer. GPC analysis (PS standard): Mw 41630, Mn 19658, Mp 38960, PDI 2.12.

To a 500 ml reactor was added the carbinol silicone polymer (Mw 41630) 219.8 g. The reactor was then placed into a 55° C. bath, and vacuumed at 3 mbar for 2 hours with stir. After the vacuum, the reactor was refilled with dry N2 gas. Reaxis 216 0.0173 g was added at this temperature, and stirred for 10 min before acryloxyethylisocyanate (A01) 3.35 g was added. The mixture was stirred for additional 2 hours. VTMO 4.44 g was then added and mixed for 10 min before cooling down to obtain the silicone diacrylate polymer.

### Example 3: Synthesis of Radiation Curable, (Meth)Acrylate Terminated Polysiloxane Polymer 3

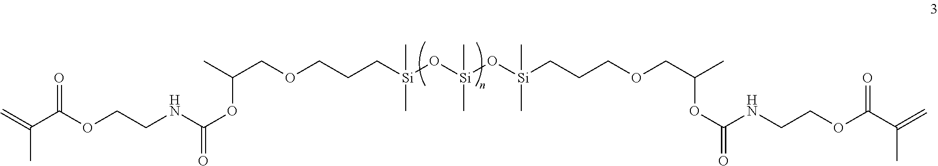

To a 3 L reactor was added octamethylcyclotetrasiloxane (D4) 2500 g, 2-hydoxypropoxy-ethyl disiloxane 23.3 g and trifluoromethanesulfonic acid 1250 μL. The reaction mixture was heated up to 90° C. with an agitation rate at 150 rpm, and stir at 90° C. for additional 2 hours. Sodium bicarbonate (NaHCO3) 20 g was then added to neutralize the acid. The reaction mixture was mixed at 90° C. for another 30 min before cooling down. The reaction mixture was filtered through a 2 micron filter pad and followed with vacuum stripping to obtain the di-carbinol silicone polymer. GPC analysis (PS standard): Mw 69651, Mn 26544, Mp 63548, PDI 2.62.

To a 1000 ml reactor was added the carbinol silicone polymer (Mw 69651) 559.6 g. The reactor was then placed into a 65° C. bath, and vacuumed at 3 mbar for 2 hours with stir. After the vacuum, the reactor was refilled with dry N2 gas. K-KAT XK-640 (King Industries) 0.0313 g was added at this temperature, and stirred for 10 min before methacryloxyethylisocyanate (MOI) 4.29 g was added. The mixture was stirred for additional 2 hours. VTMO 11.11 g was then added and mixed for 10 min before cooling down to obtain the silicone diacrylate polymer.

### Example 4: Synthesis of Radiation Curable, (Meth)Acrylate Terminated Polysiloxane Polymer 4

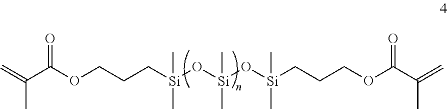

To a 500 mL reactor was added octamethylcyclotetrasiloxane (D4) 500 g, Gelest 1402.0 7.9 g, MEHQ 0.5 g and trifluoromethanesulfonic acid 250 μL. The reaction mixture was heated up to 90° C. with an agitation rate at 150 rpm, and stir at 90° C. for additional 4 hours. Sodium bicarbonate (NaHCO3) 4 g was then added to neutralize the acid. The reaction mixture was mixed at 90° C. for another 30 min before cooling down. The reaction mixture was filtered through a 2 micron filter pad and followed with vacuum stripping to obtain the di-methacrylate silicone polymer. GPC analysis (PS standard): Mw 41647, Mn 20785, Mp 38706, PDI 2.0.

### Example 5: Synthesis of Radiation Curable, (Meth)Acrylate Terminated Polysiloxane Copolymer 5

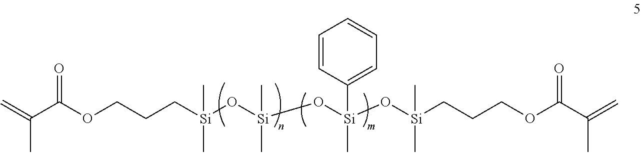

To a 500 mL reactor was added octamethylcyclotetrasiloxane (D4) 190 g, tetramethylphenylcyclotetrasiloxane (D4-Ph) 18.4 g, Shinetsu X-22-164 3.15 g and trifluoromethanesulfonic acid 100 μL. The reaction mixture was heated up to 90° C. with an agitation rate at 150 rpm, and stir at 90° C. for additional 19 hours. Sodium bicarbonate (NaHCO3) 1.6 g was then added to neutralize the acid. The reaction mixture was mixed at 90° C. for another 30 min before cooling down. The reaction mixture was filtered through a 2 micron filter pad and followed with vacuum stripping to obtain the di-methacrylate silicone polymer. GPC analysis (PS standard): Mw 30367, Mn 12814, Mp 28845, PDI 2.4.

### Example 6: Synthesis of Radiation Curable, (Meth)Acrylate Terminated Polysiloxane Polymer 6

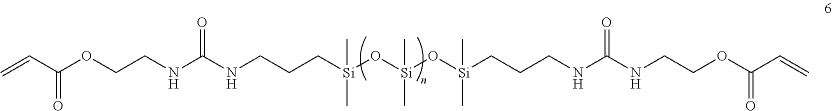

To a 500 ml reactor was added the amino silicone polymer (Gelest DMS-A35) 311 g. The reactor was then placed into a 65° C. bath, and vacuumed at 3 mbar for 3.5 hours with stir. After the vacuum, the reactor was refilled with dry N2 gas. Acryloxyethylisocyanate (A01) 1.85 g was added. The mixture was stirred for additional 2.5 hours. VTMO 6.11 g was then added and mixed for 10 min before cooling down to obtain the silicone diacrylate polymer.

### Example 7: Synthesis of Radiation Curable, (Meth)Acrylate Terminated Polysiloxane Polymer 7

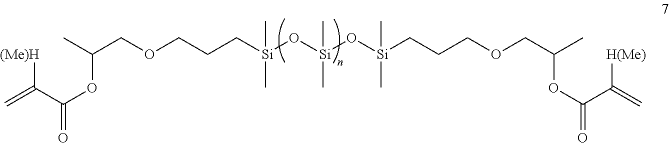

To a 5000 mL reactor was added octamethylcyclotetrasiloxane (D4) 2500 g, 2-hydoxypropoxy-ethyl disiloxane 31.2 g and trifluoromethanesulfonic acid 1250 μL. The reaction mixture was heated up to 90° C. with an agitation rate at 150 rpm, and stir at 90° C. for additional 2 hours. Sodium bicarbonate (NaHCO3) 40 g was then added to neutralize the acid. The reaction mixture was mixed at 90° C. for another 30 min before cooling down. The reaction mixture was filtered through a 2 micron filter pad and followed with vacuum stripping to obtain the di-carbinol silicone polymer. GPC analysis (PS standard): Mw 58820, Mn 24232, Mp 54116, PDI 2.4.

To a 1000 ml reactor was added the carbinol silicone polymer (X44633) 492.1 g, triethylamine 5.6 g, MEHQ 3.4 g and toluene 1149 g. The reactor was then placed into an ice/H2O bath with stir. Acryloyl chloride 4.98 g was added to above reaction mixture dropwise through an addition funnel at <4 degree C. After the addition was completed, the reaction mixture was slowly warmed up to room temperature and mixed for additional 16 hours. The resulting mixture was then passed through a pad of silica gel. Vacuum removal of the volatiles will then obtain the silicone diacrylate polymer.

### Example 8: Synthesis of Radiation Curable, (Meth)Acrylate Terminated Polysiloxane Polymer 8

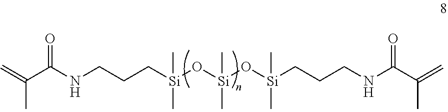

To a 1000 ml reactor was added the amino silicone polymer (Gelest DMS-A35) 214 g, MEHQ 0.37 g and toluene 671 g. The reactor was then placed into an ice/H2O bath with stir. Methacryloyl chloride 3.74 g was added to above reaction mixture dropwise through an addition funnel at <4 degree C. After the addition was completed, the reaction mixture was slowly warmed up to room temperature and mixed for additional 16 hours. The resulting mixture was then passed through a pad of silica gel. Vacuum removal of the volatiles will then obtain the silicone dimethacrylate polymer.

Polymers as described above were used to prepare various formulations, which were described in Tables herein below. Mechanical Tests were performed on said formulations.

### Example 9: Second Synthesis of Radiation Curable, (Meth)Acrylate Terminated Polysiloxane Polymer 4

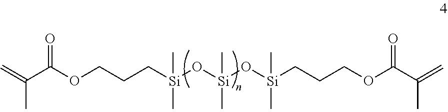

To a 1500 mL reactor was added octamethylcyclotetrasiloxane (D4) 4500 g, Gelest 1402.0 54.6 g, MEHQ 2.0 g and trifluoromethanesulfonic acid 2250 μL. The reaction mixture was heated up to 90° C. with an agitation rate at 150 rpm, and stir at 90° C. for additional 4 hours. Sodium bicarbonate (NaHCO3) 36 g was then added to neutralize the acid. The reaction mixture was mixed at 90° C. for another 30 min before cooling down. The reaction mixture was filtered through a 2 micron filter pad and followed with vacuum stripping to obtain the di-methacrylate silicone polymer. GPC analysis (PS standard): Mw 54594, Mn 26647, Mp 50644, PDI 2.1.

### Sample Cure

Samples were cured in in a Dymax 5076 UV chamber having the following output.

| | UVA | UVB | UVC | UVV |
|---|---|---|---|---|
| wavelength (nm) | 320-390 | 280-320 | 250-260 | 395-445 |
| dosage (J/cm²) | 2.37 | 0 | 0 | 2.59 |
| intensity (W/cm²) | 0.025 | 0 | 0 | 0.027 |

### Measurement of Shore a Hardness

The procedure is carried out in accordance with ASTM D2240.

### Measurement of Mechanical Properties (Tensile Test)

The breaking strength, elongation at break, and tensile stress values (modulus of elasticity) are determined by the tensile test in accordance with ASTM D638.

Curable compositions comprising the disclosed radiation curable, (meth)acrylate terminated polysiloxane polymers were prepared and tested. The results of the measurements are shown below.

### UV CURE EXAMPLES

### Example 10: Radiation Curable Composition Comprising (Meth)Acrylate Terminated Polysiloxane Polymer 1

Formulation

| | Example 10A | Example 10B |
|---|---|---|
| Raw material | (Parts) | (Parts) |
| Polymer 1 | 70 | 70 |
| Isobornyl acrylate | 19.8 | 19.8 |
| Tri (propylene glycol) diacrylate | 10 | |
| Gelest 1402.0 | | 10 |
| TPO¹ | 0.2 | 0.2 |

¹Diphenyl(2,4,6-trimethylbenzoyl)phosphine oxide radiation cure photoinitiator

The compositions of Examples 10A and 10B were formed into 40 gram, 2 mm film samples that were cured only by exposure to UV radiation in a Dymax UV chamber for 99 sec on each side of sample film.

Result of Mechanical Performance Testing on cured samples

| | cured Example 10A | cured Example 10B |
|---|---|---|
| Shore A hardness | 68 | 62 |
| Elongation at break (%) | 67% | 161% |
| Modulus (N/mm²) | 5.67 | 3.08 |
| Film appearance | clear | translucent |

### Example 11: Radiation Curable Composition Comprising (Meth)Acrylate Terminated Polysiloxane Polymer 2

Formulation

| Raw material | Example 11 (Parts) |
|---|---|
| Polymer 2 | 60 |
| Shinetsu X-22-2445 | 15 |
| organic diacrylate monomer | 15 |
| Isobornyl acrylate | 10 |
| TPO¹ | 0.5 |

¹Diphenyl(2,4,6-trimethylbenzoyl)phosphine oxide radiation cure photoinitiator

The compositions of Example 11 was formed into 40 gram, 2 mm thick film samples that were cured only by exposure to UV radiation in a Dymax UV chamber for 99 sec on each side of sample film. These cured samples are the time 0 samples prior to aging for 100 hours at 150 C.

Result of Mechanical Performance Testing on cured samples

| | Example 11 | |
|---|---|---|
| Time 0 | Shore A hardness | 63 |
| | Elongation at break (%) | 102% |
| | Tensile (N/mm²) | 2.97 |
| | Modulus (N/mm²) | 3.66 |
| | Film appearance | translucent |
| Aged 100 hour at 150 C. | Shore A hardness | 62 |
| | Elongation at break (%) | 102% |
| | Tensile (N/mm²) | 2.54 |
| | Modulus (N/mm²) | 3.30 |

Heat and/or Radiation Curable Compositions

### Example 12: Heat and/or Radiation Curable Composition Comprising (Meth)Acrylate Terminated Polysiloxane Polymer 9 Formulations and Result of Mechanical Performance Testing

Formulation

| | Formulation 12A | Formulation 12B | Formulation 12C |
|---|---|---|---|
| Raw material | (Parts) | (Parts) | (Parts) |
| Polymer 9 | 66.67 | 66.67 | 66.67 |
| Shinetsu | 13.33 | 13.33 | 13.33 |
| X-22-2445 | | | |
| 1,6-hexanediol | 19.00 | 19.80 | 18.85 |
| diacrylate | | | |
| TPO² | 1.00 | — | 0.99 |
| heat cure initiator³ | — | 0.50 | 0.40 |

1 Diphenyl(2,4,6-trimethylbenzoyl)phosphine oxide radiation cure photoinitiator
³available from Gelest as SID3352.0.

The compositions of Examples 12A, 12B and 12C were formed into 40 gram, 2 mm thick film samples. The Example 12A samples were cured only by exposure to UV radiation in a Dymax UV chamber for 99 sec on each side of sample film). The Example 12B samples were cured only by baking at a temperature of 120 C for 1 hour. The Example 12C samples were cured by exposure to UV radiation and subsequent baking at a temperature of 120 C for 1 hour. These cured samples are the time 0 samples prior to aging for 100 hours at 150 C.

| | | Result of Mechanical Performance Testing | | |
|---|---|---|---|---|
| | | on cured samples | | |
| | | Formulation | Formulation | Formulation |
| | | 12A | 12B | 12C |
| Time 0 | Modulus | 1.41 | 3.10 | 1.54 |
| | (N/mm²) | | | |
| | Tensile | 0.45 | 0.79 | 0.57 |
| | (N/mm²) | | | |
| | Elongation at | 36% | 31% | 43% |
| | break (%) | | | |
| | Film | T to W¹ | T to W | T to W |
| | appearance | | | |
| Aged | Modulus | 1.14 | 2.66 | 1.50 |
| 100 | (N/mm²) | | | |
| hours | Tensile | 0.37 | 0.94 | 0.54 |
| at | (N/mm²) | | | |
| 150 C. | Elongation at | 38% | 47% | 41% |
| | break (%) | | | |
| | Film | off white | off white | off white |
| | appearance | | | |

T to W is translucent to white

From the tests above, all of the disclosed (meth)acrylate terminated polysiloxane polymers (example 1-9) can be successfully cured using commercially standard UV curing equipment and conditions. Cured compositions comprising the (meth)acrylate terminated polysiloxane polymers showed different mechanical performance dependent upon the additives and the corresponding interactions. The composition of Example 12B comprising (meth)acrylate terminated polysiloxane polymer was successfully cured using only exposure to heat at 120 C. The Example 12B composition provided useful films with acceptable mechanical performance. The composition of Example 12C, cured using a combination of UV radiation and heat, also provided useful films with acceptable mechanical performance.

In view of the foregoing description and examples, it will be apparent to those skilled in the art that equivalent modifications thereof can be made without departing from the scope of the claims.

1. A polysiloxane polymer comprising radiation curable terminal groups having the structure of formula I 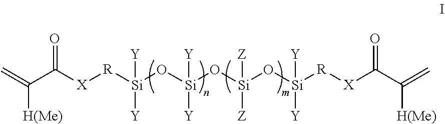
wherein:
each X is independently selected from 0 or N;
each R is a bivalent moiety independently selected from alkylene, heteroalkylene, arylene, heteroarylene, aralkylene, amine; urethane; urea; ether, ester and combinations thereof;
each Y is independently selected from H, alkyl and aryl;
each Z is independently selected from H, alkyl and aryl;
n is an integer from about 1 to about 2300; and
m is an integer from 0 to about 2300, wherein if m is greater than 1, then the n blocks and the m blocks can be arranged in any order;
wherein if each Y is alkyl, each R is alkylene, each X is O and the O atom is bonded to a primary carbon atom, than n+m is 1200 or greater.

2. The polysiloxane polymer of claim 1 wherein:
a) each X is O; or
b) each R is a bivalent moiety independently selected from alkylene, heteroalkylene, amine; urethane; urea; ether and combinations thereof; or
c) each Y is independently selected from alkyl and aryl; or
d) at least one Z is aryl; or
e) any combination of a), b), c) and d).

3. The polysiloxane polymer of claim 1, wherein each R is independently selected from C₁₋₆ alkylene, -alkylene-urethane-ether-, -amine-alkylene- and alkylene-urea-alkylene-.

4. The polysiloxane polymer of claim 1, wherein R comprises a urethane group, an ether group, an amine group and combinations thereof.

5. The polysiloxane polymer of claim 1, wherein m is 0.

6. The polysiloxane polymer of claim 1, wherein m is an integer from 1 to about 2300 and each Si atom in the m block has one phenyl Z moiety and one C₁₋₃ alkyl Z moiety.

7. The polysiloxane polymer of claim 1, wherein R comprises one or more heteroatoms.

8. The polysiloxane polymer of claim 1, wherein R has a length of 2 to 20 atoms.

9. The polysiloxane polymer of claim 1, having a) a molecular weight of 300 to 200,000 or b) a viscosity of 1 to 15,000 Cps or both a) and b).

10. Cured reaction products of the radiation curable polysiloxane polymer of claim 1.

11. A curable composition comprising the radiation curable, (meth)acrylate terminated polysiloxane polymer of claim 1.

12. A process for preparation of a radiation curable, organo-polysiloxane material, comprising:
providing a first material selected from one or more of diamino silicone polymer and carbinol silicone polymer;
providing a second material selected from one or more of (meth)acrylate terminated isocyanate, di(meth)acrylate siloxane and acrylic acid chloride;
mixing the first and second materials under polymerization conditions to form the radiation curable, organo-polysiloxane material.

13. The process of claim 12 comprising a step of reacting a hydroxyalkyl allyl ether having a secondary or tertiary alcohol group with a siloxane to form a reaction product and reacting that reaction product with at least one cyclic siloxane to form the carbinol silicone polymer first material; wherein the second material is the (meth)acrylate terminated isocyanate.
